(19) United States
(12) Patent Application Publication
(10) Pub. No.: US 2026/0054512 A1
(43) Pub. Date: Feb. 26, 2026

(54) THERMAL DONOR LAMINATES WITH ALTERNATE POLYMERS AND RELEASE AGENTS

(71) Applicant: Kodak Alaris LLC, Rochester, NY (US)

(72) Inventors: David G. Foster, West Henrietta, NY (US); Michael Schild, Honeoye Falls, NY (US); Jacob Pylypciw, Rochester, NY (US); Matthew Croteau, Rochester, NY (US)

(73) Assignee: Kodak Alaris LLC, Rochester, NY (US)

(21) Appl. No.: 19/303,665

(22) Filed: Aug. 19, 2025

Related U.S. Application Data
(60) Provisional application No. 63/685,411, filed on Aug. 21, 2024.

(51) Int. Cl. B41M 5/46

(52) U.S. Cl. CPC B41M 5/46; B41M 2205/30

(57) ABSTRACT

The thermal donor laminate system includes a release agent such as APS-705, APS-706, or APS-707. The thermal donor laminate system further includes polyvinyl acetal, poly(methyl methacrylate), cellulose acetate propionate, methacrylate beads dispersed in the thermal donor laminate system, an ultraviolet absorber agent, and toluene and methanol as solvents. The thermal donor laminate system is scratch resistant up to approximately 1000 grams.

### CROSS-REFERENCE TO RELATED APPLICATION(S)

This Non-Provisional Patent Application is related to and claims the benefit of priority from U.S. Provisional Application Number 63/685,411, titled “THERMAL DONOR LAMINATES WITH ALTERNATE POLYMERS AND RELEASE AGENTS,” filed on Aug. 21, 2024, and incorporated by reference herein in its entirety for all intents and purposes.

### FIELD OF DISCLOSURE

At least one embodiment pertains to thermal donor laminates used in printing images. More specifically, at least one embodiment pertains to thermal donor laminate polymers that use alternative substances to per-and polyfluorinated substances (PFAS).

### BACKGROUND

Printed images can be created in different ways, such as thermal, inkjet, and electrophotographic printing. For these types of printing, electronic signals indicating various colors are used to produce different color signals. These signals are then transmitted to a printer where colored material is transferred to an appropriate receiver element, and a printed color hard copy is obtained that corresponds to the original image. There can be certain issues with thermal transfer prints, such as the colorants being unwantedly transferred to adjacent surfaces, the colorants becoming discolored (e.g., via fingerprints during handling), and the prints becoming scratched during imaging and handling.

Commonly, to address the issues associated with thermal transfer prints, a laminate is applied to printed images, which is a transparent protective overcoat. The transparent protective overcoat can also provide improved light stability if an ultraviolet (UV) absorbing compound is incorporated in the formulation. The protective overcoat may also be referred to as a thermal donor laminate, or just a laminate. The transparent protective layer can be provided as the sole transferrable material in a thermal transfer donor element, or it can be provided as multiple patches, with or without separate patches containing thermal transferable dyes.

In prior art embodiments, thermal donor laminates can include release agents that provide a barrier between a molding surface and the laminate, preventing the laminate from sticking to the mold. Some prior art release agents comprise a polymer such as a fluorine modified silicone fluid, such as fluoroalkyl modified silicone (e.g., APS-689 from Advanced Polymer, Inc.) included in the laminate, which is a type of PFAS. Even though polymers containing PFAS exhibit favorable properties as a release agent in thermal donor laminates, PFAS are gradually being phased out of the industry.

### SUMMARY

Applicants recognized the problems noted above herein and conceived and developed embodiments of compression seals, according to the present disclosure, for providing alternative polymers and release agents for thermal donor laminates that do not incorporate PFAS.

In an embodiment, a thermal donor laminate system includes a release agent having a silicone fluid, polyvinyl acetal, poly(methyl methacrylate) (PMMA), and cellulose acetate propionate.

In another embodiment, a thermal donor laminate system includes a release agent having a silicone fluid, polyvinyl acetal, PMMA, cellulose acetate propionate, beads, an ultraviolet (UV) absorber agent, and a solvent, the beads being insoluble in the a solvent.

In another embodiment, a thermal donor laminate system includes a release agent. The release agent includes APS-705 at approximately 3 milligrams per square foot (mgs/sqft) of surface density or APS-707 at approximately 1.55 mgs/sqft of surface density. The thermal donor laminate system further includes polyvinyl acetal at approximately 46 mgs/sqft of surface density, PMMA at approximately 31 mgs/sqft of surface density, cellulose acetate propionate at approximately 8 mgs/sqft of surface density, methacrylate beads dispersed in the thermal donor laminate system, a UV absorber agent, and two solvents. The two solvents include toluene and methanol. The thermal donor laminate system is scratch resistant up to approximately 1000 grams.

### BRIEF DESCRIPTION OF THE DRAWINGS

Various embodiments in accordance with the present disclosure will be described with reference to the drawings, in which:

FIG. 1 is a table of various embodiments of thermal donor laminate formulations;

FIG. 2 is a graph of coverage of various embodiments of thermal donor laminate formulations; and

FIG. 3 is a table of scratch results of various embodiments of thermal donor laminate formulations.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back” in the context of the illustrated embodiments, or other terms regarding orientation or direction, are not intended to be limiting or exclude other orientations or directions. It should be further appreciated that terms such as approximately or substantially may indicate +/−10 percent.

Embodiments of the present disclosure may address and overcome problems with prior art assemblies. By way of example, configurations discussed herein may provide high quality thermal prints with a thermal donor laminate that does not include PFAS, and instead includes a release agent comprising a silicone fluid. With certain non-PFAS release agents, defects can occur (e.g., retransfer), however, embodiments of the present disclosure may avoid such defects. For example, in the case of retransfer, many release agents may act as solvents for dyes applied to a thermal print, causing the dye to mobilize on the print. Embodiments of the present disclosure may include non-PFAS release agents that do not act as a solvent for the dyes, therefore avoiding defects such as retransfer. Additionally, embodiments of the present disclosure may better protect the thermal print from scratching and/or appearing glossy to the human eye.

Embodiments of the present disclosure are directed toward systems of thermal donor laminates to be used in thermal printing applications. Embodiments of the thermal donor laminate systems include polymers. It should be appreciated that there are thousands of different polymers that have various properties when used in a thermal donor laminate. The polymers used in the thermal donor laminate will cause the thermal donor laminate to exhibit different properties depending on, for example, the monomers chosen for the polymer and the molecular weight, melting point, crystallinity, and viscosity of the polymer.

In some embodiments, a release agent may be used in the thermal donor laminate, which may be a polymer such as polysiloxane (e.g. “silicone”) due to favorable properties that polysiloxane causes in the thermal donor laminate. Specifically, the release agent used in the embodiments may be a silicone fluid, which may also act as a surfactant. In one or more embodiments, the release agent used in the thermal donor laminate may be APS-705, APS-706, or APS-707, which are silicone fluids with proprietary chemical compositions, manufactured by Advanced Polymer, Inc. It should be appreciated that APS-705, APS-706, and APS-707 do not comprise PFAS. In at least one embodiment, a thermal donor laminate system includes multiple polymers, including a polymer release agent, poly(vinyl acetal) (e.g., “PVA”), poly(methyl methacrylate) (e.g., “PMMA”), and cellulose acetate propionate (e.g., “CAP”). PVA may be considered the base polymer when included in thermal laminate formulations. CAP may serve to enable clean edges when a laminate is removed from an image after thermal printing and may also allow for a reduction in the amount of colloidal silica necessary to be used in the formulation. Including PMMA in the laminate formulation may allow for the elimination of colloidal silica and may offer various advantages. Each of the polymers may have different molecular weights in order to influence different properties in the thermal donor laminate system.

In some embodiments, an ultraviolet (UV) light absorber agent may be added to the thermal donor laminate system in order to protect the polymers against UV degradation, in which the polymer breaks down and produces free radicals. UV absorber agents typically comprise a hydroxyl group, which can absorb UV rays for molecular rearrangement to convert UV light energy to heat energy. In practice, UV absorber agents are especially useful in thermal donor laminates and allow the print to not quickly fade over time and keep its color and vibrancy longer. In an embodiment of the present disclosure, a hydroxyphenyl-triazine, such as TINUVIN 460 manufactured by BASF, may be included in the thermal donor laminate system as a UV absorber agent.

Furthermore, in some embodiments, beads (e.g., methacrylate beads or PMMA beads), that are insoluble in the solvent chosen for the thermal donor laminate system, are dispersed in the thermal donor laminate system. The beads dispersed in the thermal donor laminate system may function by allowing for spacing between one or more layers in the laminate. In some embodiments, the beads may function to provide space or separation between one or more layers in a spooled donor roll. In an embodiment, the beads may provide for traction in a finishing operation for the thermal donor laminate.

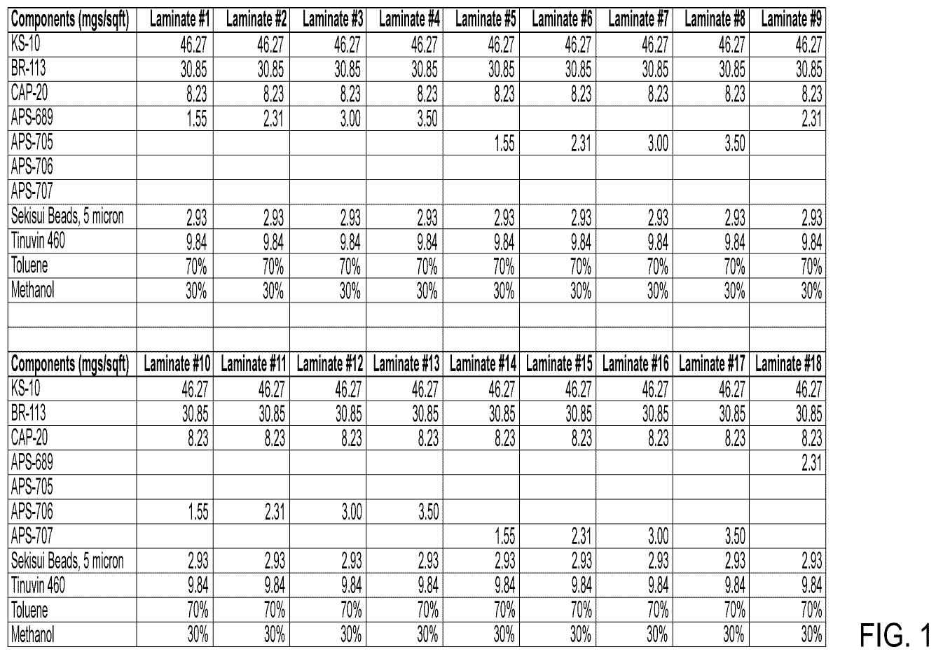

FIG. 1 shows the compositions of various thermal donor laminate formulations tested with four different release agents: APS-689, APS-705, APS-706, and APS-707. APS-689 contains PFAS and is used in an existing embodiment of the thermal donor laminate, whereas APS-705, APS-706, and APS-707 do not contain PFAS. As one would appreciate, milligrams per square feet (mgs/sqft) is a measurement of surface density commonly used in the field of thermal printing. Surface density in mgs/sqft may be considered an amount of a quantity (e.g., mass) per unit of area or the mass of a substance distributed over a given surface area. In other words, mgs/sqft may refer to how much a substance, measured in milligrams, is present on each square foot of a surface. A person of ordinary skill in the art would appreciate that mgs/sqft may be considered a non-metric measurement unit of surface or areal density and may be used to measure the thickness of paper, fabric and other thin materials. In terms of the units of surface density given herein, it is the case that there are approximately 10.76 square feet in a square meter. Therefore, any value herein given in milligrams per square meter may be multiplied by 10.76 square feet per square meter to yield a value in the units of milligrams per square meter.

In the case of FIGS. 1, 18 total laminate formulation examples are presented, and each of the release agents (e.g., APS-689, APS-705, APS-706, and APS-707), when used, were included in laminate formulations in amounts of approximately 1.55, 2.31, 3.0, and 3.5 mgs/sqft. It should be appreciated that other reasonable amounts of release agent in the laminate formulation may be used (such as less than 1.55 mgs/sqft, or more than 3.5 mgs/sqft), and more or fewer laminate formulations may be generated using different combinations or ranges of release agents. In each of the thermal donor laminate formulations in FIG. 1, an equal amount of other polymers, beads, UV absorber agent, and solvent were used in order to study the effects that different release agents and release agent amounts had on the properties of the laminate. In each case, poly(vinyl acetal) resin may be used as one of the polymers in the laminate formulation. Specifically, the poly(vinyl acetal) used in one or more laminates may be KS-10, which is a type of poly(vinyl acetal) of a particular molecular weight, manufactured by SEKISUI Specialty Chemicals. In one or more embodiments, such as the embodiments shown in FIG. 1, the thermal donor laminate may comprise a surface density of approximately 46.27 mgs/sqft of KS-10. However, it should be appreciated that poly(vinyl acetal) in amounts more or less than 46.27 mgs/sqft are contemplated in embodiments of the present disclosure. Additionally, poly(vinyl acetal) of different molecular weights, such as poly(vinyl acetal) other than KS-10, may be implemented in one or more embodiments of the thermal donor laminate.

Furthermore, in each laminate formulation of FIG. 1, PMMA may be used as one of the polymers in the laminate formulation. Specifically, the PMMA used in one or more laminates may be BR-113, which is a type of PMMA of a particular molecular weight, manufactured by DIANAL America, Inc. In one or more embodiments, such as the embodiments shown in FIG. 1, the thermal donor laminate may comprise a surface density of approximately 30.85 mgs/sqft of BR-113. However, it should be appreciated that PMMA in amounts more or less than 30.85 mgs/sqft are contemplated in embodiments of the present disclosure. Additionally, PMMA of different molecular weights, such as PMMA other than BR-113, may be implemented in one or more embodiments of the thermal donor laminates.

Additionally, in each laminate formulation of FIG. 1, cellulose acetate propionate may be used as one of the polymers in the laminate formulation. Specifically, the cellulose acetate propionate used in one or more laminates may be CAP-20, which is a type of cellulose acetate propionate of a particular molecular weight, manufactured by EASTMAN. In one or more embodiments, such as the embodiments shown in FIG. 1, the thermal donor laminate may comprise a surface density of approximately 8.23 mgs/sqft of CAP-20. However, it should be appreciated that cellulose acetate propionate in amounts more or less than 8.23 mgs/sqft are contemplated in embodiments of the present disclosure. Additionally, cellulose acetate propionate of different molecular weights, such as cellulose acetate propionate other than CAP-20, may be implemented in one or more embodiments of the thermal donor laminates.

Moreover, in each laminate formulation of FIG. 1, beads may be used as one of the polymers in the laminate formulation. Specifically, the beads used in one or more laminates may be SEKISUI methacrylate beads, which are a type of bead of a particular molecular weight, manufactured by SEKISUI Specialty Chemicals. In an embodiment, at least some of the beads are insoluble in the solvents chosen for the thermal donor laminate. In one or more embodiments, such as the embodiments shown in FIG. 1, the thermal donor laminate may comprise a surface density of approximately 2.93 mgs/sqft of SEKISUI beads. However, it should be appreciated that beads in amounts more or less than 2.93 mgs/sqft are contemplated in embodiments of the present disclosure. Additionally, beads of different molecular weights, such as beads other than SEKISUI methacrylate beads, and beads of a different polymer than methacrylate, may be implemented in one or more embodiments of the thermal donor laminates. In at least one embodiment, such as the embodiments shown in FIG. 1, the diameter of the beads may be approximately 5 micron. However, it should be appreciated that the beads may be of different diameter sizes. Additionally, it should be appreciated that there may be one or more different diameter sizes of the beads included in the thermal donor laminate formulations.

In one or more embodiments of the laminate formulations of FIG. 1, the polymer release agent (whether APS-689, APS-705, APS-706, or APS-707), KS-10, BR-113, and CAP-20 are combined with one or more solvents to dissolve the polymers. For example, the solvent may be toluene, benzene, methanol, ethanol, isopropanol, acetone, methyl acetate, ethyl acetate, hexane, dimethyl sulfoxide (DMSO), dichloromethane (DCM), or any combination thereof. Since the multiple polymers are typically not soluble in a single solvent, typically two solvents are chosen to take advantage of the cosolvent effect. In an embodiment of the present disclosure, such as the embodiments shown in FIG. 1, toluene and methanol are used in conjunction to dissolve the polymers in the thermal donor laminate system. In each of the laminate formulations shown in FIG. 1, the solvent comprises approximately 70% toluene and approximately 30% methanol. However, it should be appreciated that alternate proportions of toluene and methanol may be used, such as, but not limited to: approximately 10% toluene and approximately 90% methanol, approximately 30% toluene and approximately 70% methanol, approximately 50% toluene and approximately 50% methanol, and approximately 90% toluene and approximately 10% methanol. Additionally, it should be appreciated that other combinations of solvents, besides toluene and methanol, may be used in one or more embodiment of the thermal donor laminate. For example, the solvents used in the thermal donor laminate formulations may be benzene and ethanol, toluene and isopropanol, and benzene and methanol, among others. It should also be appreciated that a single solvent may be used in the thermal donor laminate formulations, such as the solvent consisting only of toluene, or the solvent consisting only of methanol.

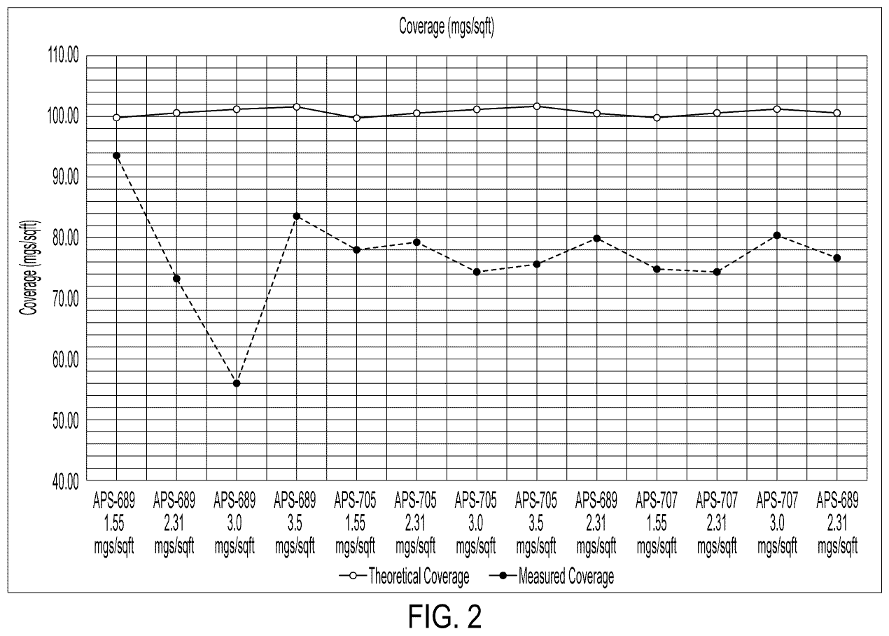

FIG. 2 is a graph of coverage of embodiments of thermal donor laminate formulations of FIG. 1. Coverage may first be theorized, then measured, for each thermal donor laminate formulation, and coverage is a measure of the amount of material in a final coated product layer. Generally, higher coverage may be associated with more material coated, and higher coverage may be better from a performance perspective but may result in increased cost. Additionally, higher coverage may indicate the layer is too thick, thereby losing structural integrity, whereas lower coverage may indicate the layer is too thin, thereby not performing adequately. In practice, there may be an optimal level of coverage that satisfies one or more of: performance, structural integrity, and cost. As can be seen in FIG. 2, coverage may be measured in mgs/sqft, and the thermal donor laminate formulations tested were: APS-689 at approximately 1.55, 2.31, 3.0, and 3.5 mgs/sqft; APS-705 at approximately 1.55, 2.31, 3.0, and 3.5 mgs/sqft, and APS-707 at approximately 1.55, 2.31, and 3.0 mgs/sqft. All of the theorized coverages are between approximately 100 mgs/sqft and approximately 102 mgs/sqft. Each of the non-PFAS formulations (e.g., APS-705 and APS-707) have coverage amounts between approximately 74 mgs/sqft and approximately 80 mgs/sqft.

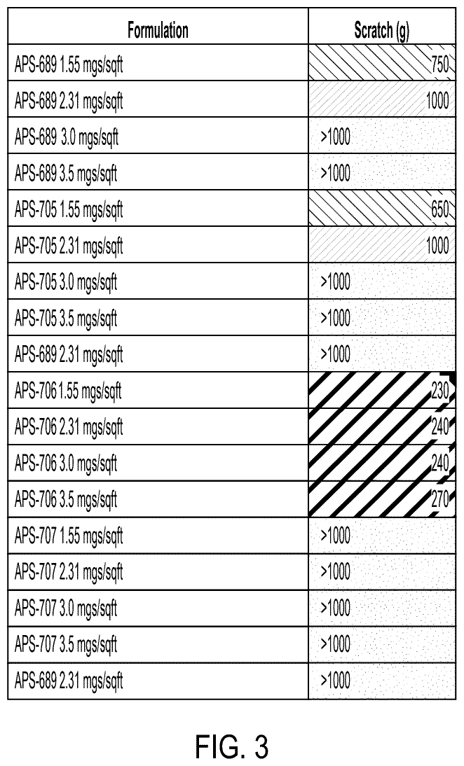

FIG. 3 is a table of scratch resistance results of embodiments of thermal donor laminate formulations of FIG. 1. In scratch testing, weighted stylists of different masses are passed on top of a thermal print, and then the print is observed to determine whether the weighted stylist scratched the print. For example, a weighted stylist having a mass of approximately 200 grams may be passed on top of a thermal print, if no scratching is observed, a weighted stylist having a mass of approximately 300 grams may next be used. This process may be repeated up to a weighted stylist having a mass of approximately 1000 grams. If the thermal print created from a thermal donor laminate formulation does not scratch at 1000 grams, the formulation may be acceptable for commercial applications. As can be seen in FIG. 3, of the non-PFAS formulations tested, APS-705 at approximately 3.0 mgs/sqft and approximately 3.5 mgs/sqft exhibited scratch resistance of more than 1000 grams. Additionally, APS-707 at approximately 1.55, 2.31, 3.0, and 3.5 mgs/sqft all exhibited scratch resistance of more than 1000 grams. Notably, the scratch resistance tests of FIG. 3 indicated that thermal donor laminate formulations with APS-706 were not viable at any of the surface densities tested, because formulations comprising APS-706 were not able to be scratch resistant when using weighted stylists having a mass of more than approximately 270 mgs/sqft.

There may be one or more other tests conducted on the formulations of the thermal donor laminates discussed herein. For example, the laminates may be tested using sensitometry to determine whether the laminate is affecting the color of the dye. As another example, the laminates may be tested using viscometry to ensure that the laminate formulations have a viscosity of approximately 39 centipoise to approximately 43 centipoise. As yet another example, the laminates may be tested for glossiness.

There may be one or more types and amounts of release agent that are preferred in embodiments of the thermal donor laminate based on tests for coverage, viscosity, scratch resistance, sensitometry, etc. Of the numerous thermal donor laminate formulations shown in FIG. 1, tested for coverage in FIG. 2, tested for scratch resistance in FIG. 3, a preferred embodiment of the thermal donor laminate may comprise APS-705 at amounts of approximately 3 mgs/sqft or more. Another preferred embodiment of the thermal donor laminate may comprise APS-707 at amounts of approximately 1.55 mgs/sqft.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A thermal donor laminate system, comprising:
a release agent comprising a silicone fluid;
polyvinyl acetal;
poly(methyl methacrylate) (PMMA); and
cellulose acetate propionate.

2. The thermal donor laminate system of claim 1, wherein the thermal donor laminate system is scratch resistant up to approximately 1000 grams.

3. The thermal donor laminate system of claim 1, wherein the release agent comprises APS-705.

4. The thermal donor laminate system of claim 3, wherein the APS-705 comprises at least approximately 3 milligrams per square foot (mgs/sqft) of surface density.

5. The thermal donor laminate system of claim 3, further comprising:
at least one solvent, wherein the at least one solvent comprises toluene and methanol.

6. The thermal donor laminate system of claim 5, wherein the toluene comprises approximately 70% of the at least one solvent and the methanol comprises approximately 30% of the at least one solvent.

7. The thermal donor laminate system of claim 1, wherein the release agent comprises APS-706.

8. The thermal donor laminate system of claim 1, wherein the release agent comprises APS-707.

9. The thermal donor laminate system of claim 8, wherein the APS-707 comprises at least approximately 1.55 milligrams per square foot (mgs/sqft) of surface density.

10. The thermal donor laminate system of claim 8, further comprising:
at least one solvent, wherein the at least one solvent comprises toluene and methanol.

11. The thermal donor laminate system of claim 10, wherein the toluene comprises approximately 70% of the at least one solvent and the methanol comprises approximately 30% of the at least one solvent.

12. A thermal donor laminate system, comprising:
a release agent comprising a silicone fluid;
polyvinyl acetal;
poly(methyl methacrylate) (PMMA);
cellulose acetate propionate;
beads;
an ultraviolet (UV) absorber agent; and
at least one solvent, wherein the beads are insoluble in the at least one solvent.

13. The thermal donor laminate system of claim 12, wherein the thermal donor laminate system is scratch resistant up to approximately 1000 grams.

14. The thermal donor laminate system of claim 12, wherein the UV absorber agent comprises hydroxyphenyl-triazine.

15. The thermal donor laminate system of claim 12, wherein the beads comprise methacrylate beads, and wherein the methacrylate beads comprise at least approximately 3 milligrams per square foot (mgs/sqft) of surface density.

16. The thermal donor laminate system of claim 15, wherein a diameter of the methacrylate beads is approximately 5 micron.

17. A thermal donor laminate system, comprising:
a release agent, comprising:
APS-705 comprising at least approximately 3 milligrams per square foot (mgs/sqft) of surface density; or
APS-707 comprising at least approximately 1.55 mgs/sqft of surface density;
polyvinyl acetal comprising at least approximately 46 mgs/sqft of surface density;
PMMA comprising at least approximately 31 mgs/sqft of surface density;
cellulose acetate propionate comprising at least approximately 8 mgs/sqft of surface density;
methacrylate beads dispersed in the thermal donor laminate system;
a UV absorber agent; and
at least two solvents, wherein the at least two solvents comprise toluene and methanol;
wherein the thermal donor laminate system is scratch resistant up to approximately 1000 grams.

18. The thermal donor laminate system of claim 17, wherein the UV absorber agent comprises hydroxyphenyl-triazine.

19. The thermal donor laminate system of claim 18, wherein the methacrylate beads comprise at least approximately 3 mgs/sqft of surface density.

20. The thermal donor laminate system of claim 19, wherein a diameter of the methacrylate beads is approximately 5 micron.
